(19) United States
(12) Patent Application Publication
(10) Pub. No.: US 2012/0049741 A1
(43) Pub. Date: Mar. 1, 2012

(54) CURRENT BALANCE SCHEME FOR DRIVING LED STRINGS AND THE METHOD THEREOF

(76) Inventors: Zhijun Ye, Hangzhou (CN); Yuancheng Ren, Hangzhou (CN); Lei Du, Hangzhou (CN); Naixing Kuang, Hangzhou (CN); Kaiwei Yao, (US); James C. Moyer, (US); Eric Yang, (US)

(21) Appl. No.: 13/216,205

(22) Filed: Aug. 23, 2011

(30) Foreign Application Priority Data
Aug. 24, 2010 (CN) 201010269938.5

(51) Int. Cl. H05B 37/02

(52) U.S. Cl. 315/122; 315/192

(57) ABSTRACT

A current balance scheme for driving LED strings is disclosed. A power supply unit provides a driving voltage to drive a plurality of LED strings. A feedback selector is configured to select a minimum feedback signal indicative of the driving voltage to the power supply unit for regulating the driving voltage. Based on the minimum feedback signal, the driving voltage gets a minimum value to sufficiently drive the plurality of LED strings. A protection circuit is configured to protect the current balance circuit from high voltage especially when there is a shorted LED string.

### CROSS-REFERENCE TO RELATED APPLICATION(S)

This application claims priority to and the benefit of Chinese Patent Application No. 201010269938.5, filed Aug. 24, 2010, which is incorporated herein by reference in its entirety.

### TECHNICAL FIELD

The present disclosure relates generally to electrical circuits, and more particularly but not exclusively to LED drivers.

### BACKGROUND

Light emitting diode (LED) has become increasingly popular as a lighting choice, and for many applications, has begun to replace conventional lamps having a filament. For example, LED is now widely used in traffic signal lights and for the back lighting of liquid crystal display (LCD) panels.

The LEDs are often arranged in parallel “strings” driven by a shared voltage source, and each LED string has a plurality of LEDs connected in series. To provide consistent light output between the LED strings, each LED string is typically driven at a regulated current that is substantially equal among all of the LED strings.

Although driven by currents of equal magnitude, there is often a considerable variation in the driving voltages due to variations in the forward-voltage drop of individual LED of the LED strings resulting from process variations in the fabrication and manufacturing of the LED. Dynamic variations due to changes in temperature when the LEDs are enabled and disabled may also contribute to the variation in the driving voltages with a fixed current. In view of this variation, conventional LED drivers typically provide a driving voltage that is sufficiently higher than an expected worst-case bias drop, so as to ensure proper operation of each LED string. However, as the power consumed by the LED driver and the LED strings is approximately a product of the output voltage of the LED driver and the sum of the currents of the individual LED strings, the use of an excessively high driving voltage unnecessarily increases the power consumption. Accordingly, an improved technique for driving LED strings would be advantageous.

FIG. 1 schematically shows a prior art LED driver 10. In FIG. 1, the LED driver 10 is realized by a power supply unit configured to supply a driving voltage to a plurality of LED strings. Each LED string is respectively coupled to an adjusting resistor R_{B} in series. All the adjusting resistors are coupled to the drain of an N-type MOSFET (Metal Oxide Semiconductor Field Effect Transistor). The source of the N-type MOSFET is coupled to a feedback resistor Rs. The current flowing through each LED string flows through the feedback resistor Rs. The voltage across the feedback resistor Rs is fed back to a pin FB of the power supply unit to regulate the driving voltage. In addition, the power supply unit provides a dimming signal through a DIM pin to the gate of the N-type MOSFET to adjust the conductance of the NMOS, thereby regulating the current flowing through the LED strings. The value of the adjusting resistor R_{B} in each LED string may be adjusted to make the current in each LED string be substantially similar. However, it is difficult to precisely balance the current in each LED string by the adjusting resistors. Meanwhile, the adjusting resistors in each LED string consume lots of power especially when the current flowing through the LED strings is high. Moreover, the N-type MOSFET coupled between the adjusting resistor and the feedback resistor suffers from high voltage when there is a shorted LED string. The N-type MOSFET may be broken down when the driving voltage is too high.

FIG. 2 schematically shows another prior art LED driver 20. The same parts of FIG. 2 with FIG. 1 are not described for brevity. In FIG. 2, each LED string is respectively coupled to a current source CS. The current provided by the current sources is set by a setting resistor R_{SET}. A voltage divider consisting of R₁ and R₂ is couple to the output of the power supply unit. The power supply unit gets a feedback signal generated by the voltage divider to regulate the driving voltage of the LED strings. The current sources in FIG. 2 may be regulated by a dimming signal from the DIM pin of the power supply unit too, and may balance the current flowing through each LED string as well. But the power dissipation on the current sources is huge. Moreover, the current source in a shorted LED string suffers from high voltage and may be damaged thereby.

The present disclosure provides a current balance scheme for driving a plurality of LED strings which is free from the shorted voltage damage and huge power dissipation, and the method thereof.

### SUMMARY

It is an object of the present disclosure to provide a current balance scheme for driving a plurality of LED strings and the method thereof.

In accomplishing the above and other objects, there has been provided, in accordance with an embodiment of the present disclosure, a LED driver, comprising: a power supply unit having an input terminal, a feedback terminal, and an output terminal, wherein the input terminal is configured to receive an input signal, the feedback terminal is configured to receive a minimum feedback signal, and wherein based on the input signal and the minimum feedback signal, the power supply unit generates a driving voltage at the output terminal to drive a plurality of LED strings, wherein the plurality of LED strings comprises N LED strings coupled in parallel, and wherein N is a natural number, and each LED string comprises an upper end and a lower end; a current balancing circuit having an input terminal and N output terminals, wherein N is a natural number, and wherein the input terminal is configured to receive a reference voltage, and each output terminal is respectively coupled to the lower end of each LED string to provide a regulated current to each LED string; and a feedback selector having N input terminals and an output terminal, wherein N is a natural number, and wherein each input terminal is respectively coupled to the lower end of each LED string to receive a feedback signal indicative of a voltage drop of each LED string, and based on the feedback signals, the feedback selector generates the minimum feedback signal at the output terminal.

In addition, there has been provided, in accordance with an embodiment of the present disclosure, A LED driver, comprising: a power supply unit circuit for generating a driving signal to drive a plurality of LED strings in response to an input signal and a minimum feedback signal; a current balancing circuit for providing a regulated current signal to the plurality of LED strings in response to a reference voltage; and a feedback selector circuit for generating the minimum feedback signal in response to a plurality of feedback signals.

Furthermore, there has been provided, in accordance with an embodiment of the present invention, a method of driving a plurality of LED strings, comprising: receiving an input signal; deriving feedback signals indicative of voltage drops of each LED string; generating a minimum feedback signal by selecting a feedback signal with minimum magnitude from the feedback signals; providing a regulated current signal to each LED string, wherein the current of each LED string is substantially similar; and generating a driving voltage in response to the input signal and the minimum feedback signal, the driving voltage being used to drive the plurality of LED strings.

These and other features of the present disclosure will be readily apparent to persons of ordinary skill in the art upon reading the entirety of this disclosure, which includes the accompanying drawings and claims.

### BRIEF DESCRIPTION OF THE DRAWINGS

FIG. 1 schematically shows a prior art LED driver 10.

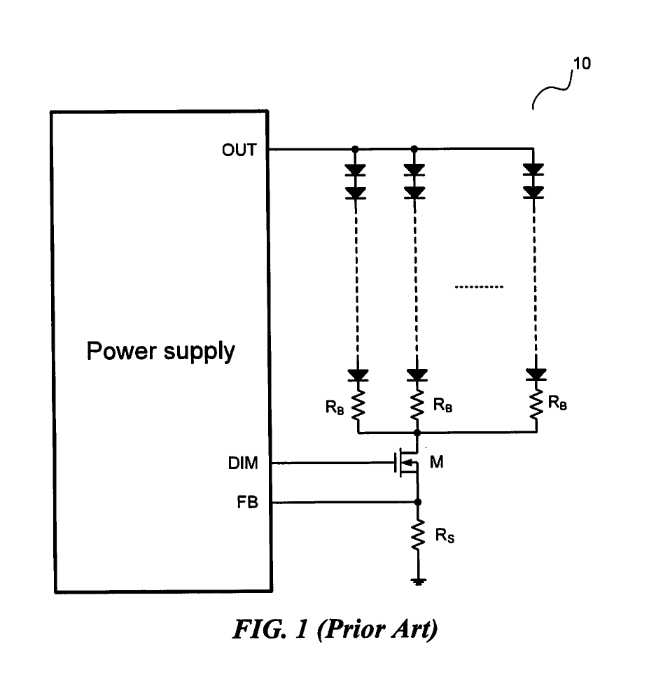

FIG. 2 schematically shows a prior art LED driver 20.

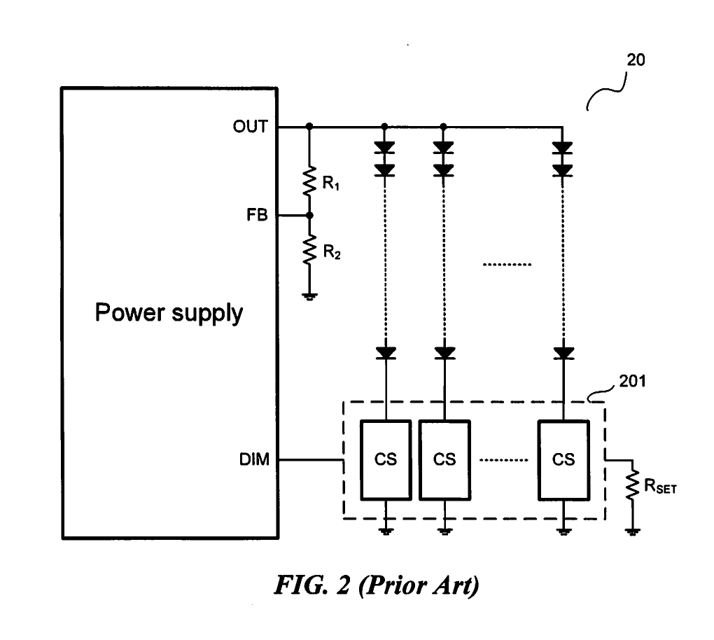

FIG. 3 schematically shows a LED driver 30 in accordance with an embodiment of the present disclosure.

FIG. 4 schematically shows a current source 40 in accordance with an embodiment of the present disclosure.

FIG. 5 schematically shows a LED driver 50 in accordance with an embodiment of the present disclosure.

FIG. 6 shows a schematic flowchart 60 of the method of controlling a LED driver in accordance with en embodiment of the present disclosure.

The use of the same reference label in different drawings indicates the same of like components.

### DETAILED DESCRIPTION

In the present disclosure, numerous specific details are provided, such as examples of circuits, components, and methods, to provide a thorough understanding of embodiments of the disclosure. Persons of ordinary skill in the art will recognize, however, that the disclosure may be practiced without one or more of the specific details. In other instances, well-known details are not shown or described to avoid obscuring aspects of the disclosure.

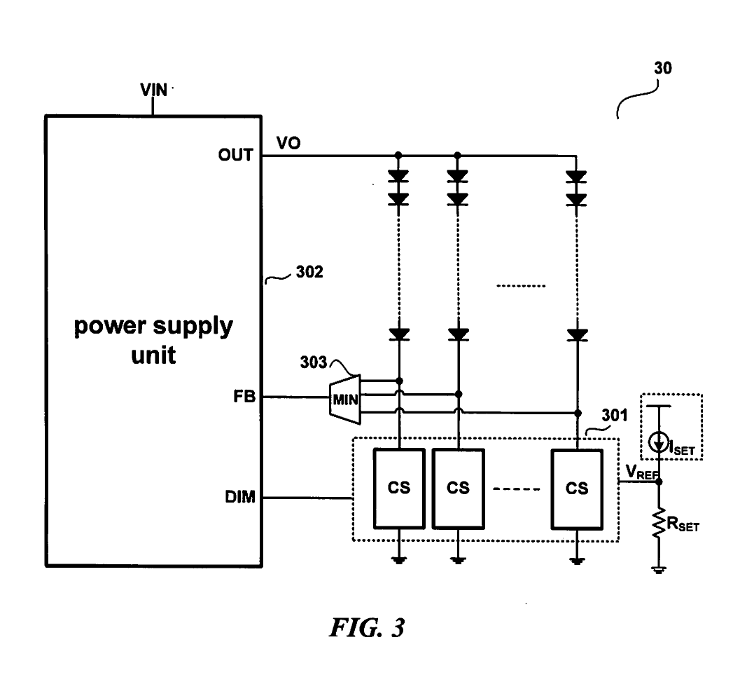

FIG. 3 schematically shows a LED driver 30 in accordance with an embodiment of the present disclosure. In the example of FIG. 3, the LED driver 30 comprises: a power supply unit 302 having an input terminal, a feedback terminal, and an output terminal, wherein the input terminal is configured to receive an input signal, the feedback terminal is configured to receive a minimum feedback signal, and wherein based on the input signal and the minimum feedback signal, the power supply unit 302 generates a driving voltage at the output terminal to drive a plurality of LED strings, wherein the plurality of LED strings comprises N LED strings coupled in parallel, wherein N is a natural number, and each LED string comprises an upper end and a lower end; a current balancing circuit 301 having an input terminal and N output terminals, wherein N is a natural number, and wherein the input terminal is configured to receive a reference voltage, and each output terminal is respectively coupled to the lower end of each LED string to provide a regulated current to each LED string; and a feedback selector 303 having N input terminals and an output terminal, wherein N is a natural number, and wherein each input terminal is respectively coupled to the lower end of each LED string to receive a feedback signal indicative of a voltage drop of each LED string, and based on the feedback signals, the feedback selector 303 generates the minimum feedback signal at the output terminal.

In FIG. 3, the power supply unit 302 regulates the driving voltage based on the minimum feedback signal, wherein the driving voltage thereby has the minimum value to sufficiently drive the plurality of LED strings. The power supply unit may comprise any kinds of voltage regulator. The current flowing through the LED strings is determined by the current balancing circuit 301 which may be an integrated circuit or several discrete components.

In one embodiment, the current balancing circuit 301 comprises: a plurality of current sources, wherein each single current source CS is coupled to the lower end of each LED string, to supply and regulate the current of each LED string, and wherein the voltage across each current source CS is coupled to the feedback selector 303 as the feedback signal; and a current setting resistor RSET having a first terminal and a second terminal, wherein the first terminal is coupled to every current source CS and the second terminal is connected to ground, and wherein the current supplied by the current source CS is adjusted by changing the value of the current setting resistor R_{SET}.

The feedback signals indicative of the driving voltage are all coupled to the feedback selector 303. In the example of FIG. 3, the feedback selector 303 is configured to provide the minimum feedback signal by selecting a feedback signal with minimum magnitude from all feedback signals, so as to get a minimum driving voltage which is sufficient to drive all of the LED strings. The minimum driving voltage decreases the power dissipation caused by the excessively high driving voltage which is used to ensure proper operation of each LED string.

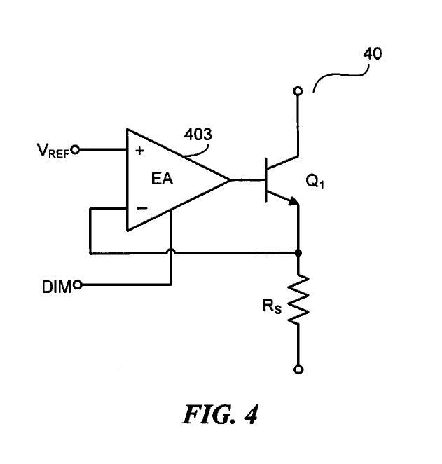

In one embodiment, the power supply unit 302 further comprises a dimming output terminal configured to provide a dimming signal to each current source. The dimming signal may be a pulse width modulation (PWM) signal. The function of the dimming signal is described with referring to FIG. 4.

FIG. 4 schematically shows a current source 40 in accordance with an embodiment of the present disclosure. Persons of ordinary skill in the art should know that the current source CS used in the current balancing circuit 301 of FIG. 3 may be realized in other ways. In one embodiment, the current source 40 comprises: an amplifier EA having a first input terminal, a second input terminal, and an output terminal, wherein the first input terminal is configured to receive the reference voltage V_{REF}, the second input terminal is coupled to a current adjusting resistor Rs to receive a voltage drop of the current adjusting resistor Rs, and based on the reference signal V_{REF} and the voltage drop of the current adjusting resistor Rs, the amplifier EA provides an amplified signal at the output terminal; the current adjusting resistor Rs coupled between the second input terminal of the amplifier EA and ground; and a transistor Q1 having a first terminal, a second terminal and a control terminal, wherein the first terminal is coupled to the conjunction of the amplifier EA and the current adjusting resistor Rs, the control terminal is coupled to the output terminal of the amplifier EA to receive the amplified signal, and the second terminal is coupled to the lower end of the corresponding LED string to provide a regulated current to each LED string.

Due to the “short” characteristic of the amplifier EA, the voltage across the adjusting resistor Rs is clamped to the reference voltage V_{REF} by the amplifier EA, so that the current flowing through the adjusting resistor Rs is fixed to V_{REF}/Rs. The current supplied by each current source may be regulated by changing the adjusting resistor Rs if the reference voltage V_{REF} is fixed. The reference voltage V_{REF} of all current sources is supplied by one voltage source to eliminate the variance. In one embodiment, the reference voltage V_{REF} is the voltage across the setting resistor R_{SET} in FIG. 3. A current source I_{SET} supplies current to the setting resistor R_{SET}. Persons or ordinary skill in the art should know that the current source I_{SET} may be provided by the power supply unit 302. The voltage across the setting resistor R_{SET} could be regulated by modifying the current source I_{SET} or the setting resistor R_{SET}. The dimming signal generated by the power supply unit is used to control the amplifier EA of the current source 40, and thereby regulates the current of the current source.

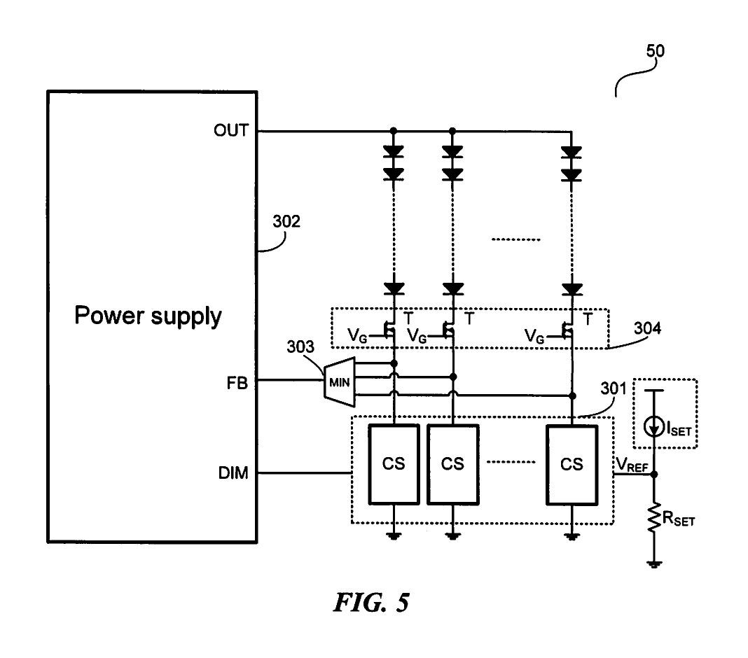

FIG. 5 schematically shows a LED driver 50 in accordance with an embodiment of the present disclosure. Compared to the example in FIG. 3, the LED driver 50 in FIG. 5 further comprises a protection circuit 304 coupled between the lower end of the LED strings and the current balancing circuit 301, to protect the current balancing circuit 301 from over voltage.

In one embodiment, the protection circuit 304 comprises N transistors, wherein each transistor T has a first terminal, a second terminal and a control terminal, and wherein the control terminal of the transistor is coupled to a predetermined voltage V_{G}, the first terminal of each transistor is respectively coupled to the lower end of each LED string, and the second terminal of the transistor T is coupled to the current balancing circuit 301, and further wherein each transistor T has a breakdown voltage higher than the driving voltage. Persons of ordinary skill in the art should know that the transistor T may be realized by MOSFET, triode, JFET and other semiconductor devices.

The operation of the LED driver 50 is similar to the operation of the LED driver 30. The protection circuit protects the current balancing circuit from high voltage which maybe the driving voltage when the LED string coupled to this current balancing circuit is shorted. The breakdown voltage of the transistor used in the protection circuit is chosen to be higher than the driving voltage so as to suffer the most of the driving voltage when the LED string is shorted. Thus the current source CS is protected.

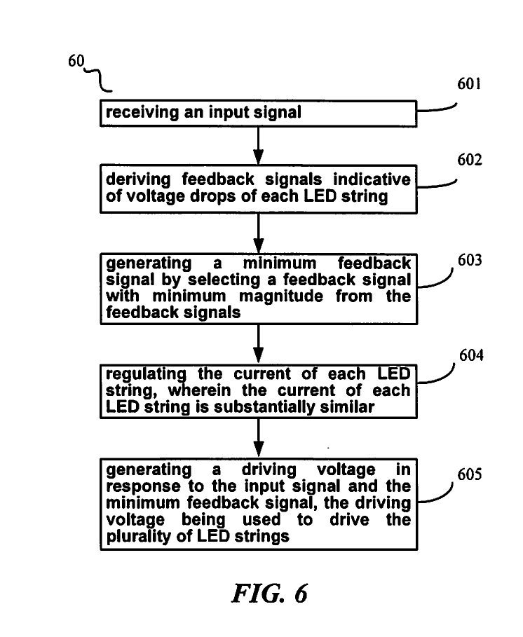

Furthermore, the present disclosure discloses a method of controlling a LED driver. Referring to FIG. 6, a schematic flowchart 60 of the method is shown in accordance with an embodiment of the present disclosure. The method comprises: step 601, receiving an input signal; step 602, deriving feedback signals indicative of voltage, drops of each LED string; step 603, generating a minimum feedback signal by selecting a feedback signal with minimum magnitude from the feedback signals; step 604, providing regulated current to each LED string, wherein the current of each LED string is substantially similar; and step 605, generating a driving voltage in response to the input signal and the minimum feedback signal, the driving voltage being used to drive the plurality of LED strings.

An effective technique for getting the feedback signal from the primary side of the switching mode power supply has been disclosed. While specific embodiments of the present disclosure have been provided, it is to be understood that these embodiments are for illustration purposes and not limiting. Many additional embodiments will be apparent to persons of ordinary skill in the art reading this disclosure.

I/we claim:

1. A light emitting diode (LED) driver, comprising:
a power supply unit having an input terminal, a feedback terminal, and an output terminal, wherein the input terminal is configured to receive an input signal, the feedback terminal is configured to receive a minimum feedback signal, and wherein based on the input signal and the minimum feedback signal, the power supply unit generates a driving voltage at the output terminal to drive a plurality of LED strings, wherein the plurality of LED strings comprises N LED strings coupled in parallel, and wherein N is a natural number, and each LED string comprises an upper end and a lower end;
a current balancing circuit having an input terminal and N output terminals, wherein N is a natural number, and wherein the input terminal is configured to receive a reference voltage, and each output terminal is respectively coupled to the lower end of each LED string to provide a regulated current to each LED string; and
a feedback selector having N input terminals and an output terminal, wherein N is a natural number, and wherein each input terminal is respectively coupled to the lower end of each LED string to receive a feedback signal indicative of a voltage drop of each LED string, and based on the feedback signals, the feedback selector generates the minimum feedback signal at the output terminal.

2. The LED driver of claim 1, wherein the current balancing circuit comprises N current sources respectively serially coupled to each LED string to provide the regulated current to each LED string, wherein N is a natural number.

3. The LED driver of claim 2, wherein each current source comprises:
an amplifier having a first input terminal, a second input terminal, and an output terminal, wherein the first input terminal is configured to receive the reference voltage, the second input terminal is coupled to a current adjusting resistor to receive a voltage drop of the current adjusting resistor, and based on the reference signal and the voltage drop of the current adjusting resistor, the amplifier provides an amplified signal at the output terminal;
the current adjusting resistor coupled between the second input terminal of the amplifier and ground; and
a transistor having a first terminal, a second terminal and a control terminal, wherein the first terminal is coupled to the conjunction of the amplifier and the current adjusting resistor, the control terminal is coupled to the output terminal of the amplifier to receive the amplified signal, and the second terminal is coupled to the lower end of the corresponding LED string to provide the regulated current to each LED string.

4. The LED driver of claim 2, wherein each regulated current is substantially similar.

5. The LED driver of claim 2, wherein the power supply unit further comprises a dimming output terminal configured to provide a dimming signal to each current source.

6. The LED driver of claim 1, wherein the feedback selector provides the minimum feedback signal by selecting a feedback signal with minimum magnitude from all feedback signals.

7. The LED driver of claim 1, further comprising a protection circuit coupled between the lower end of the LED strings and the current balancing circuit, to protect the current balancing circuit from over voltage.

8. The LED driver of claim 7, wherein the protection circuit comprises N transistors, wherein each transistor has a first terminal, a second terminal and a control terminal, and wherein the control terminal of the transistor is coupled to a predetermined voltage, the first terminal of each transistor is respectively coupled to the lower end of each LED string, and the second terminal of the transistor is coupled to the current balancing circuit, and further wherein each transistor has a breakdown voltage higher than the driving voltage.

9. The LED driver of claim 1, wherein the power supply unit comprises a voltage regulator.

10. The LED driver of claim 1, wherein the reference voltage signal is the voltage across a current setting resistor.

11. A LED driver, comprising:
a power supply unit circuit for generating a driving signal to drive a plurality of LED strings in response to an input signal and a minimum feedback signal;
a current balancing circuit for providing a regulated current signal to the plurality of LED strings in response to a reference voltage; and
a feedback selector circuit for generating the minimum feedback signal in response to a plurality of feedback signals.

12. The LED driver of claim 11, wherein the power supply unit circuit for generating a driving signal comprises a regulator.

13. The LED driver of claim 11, wherein the current balancing circuit for generating a regulated current signal comprises a plurality of current sources coupled to the plurality of LED strings, respectively.

14. The LED driver of claim 13, wherein the current source comprises:
a current adjusting resistor having a first terminal and a second terminal;
an amplifier having a first input terminal, a second input terminal, and an output terminal, wherein the first input terminal is configured to receive the reference voltage, the second input terminal is coupled to the first terminal of the current adjusting resistor to receive a voltage drop signal based on a current flowing through the current adjusting resistor, and based on the reference signal and the voltage drop signal, the amplifier provides an amplified signal at the output terminal;
and wherein the second terminal of the current adjusting resistor is coupled to ground; and
a transistor having a first terminal, a second terminal and a control terminal, wherein the first terminal is coupled to the second input terminal of the amplifier and to the first terminal of the current adjusting resistor, the control terminal is coupled to the output terminal of the amplifier to receive the amplified signal, and the second terminal is coupled to the lower end of the corresponding LED string to provide the regulated current to each LED string.

15. The LED driver of claim 11, wherein the feedback selector circuit for generating the minimum feedback signal generates the minimum feedback signal by selecting a feedback signal with a lowest voltage level from the plurality of feedback signals.

16. The LED driver of claim 15, wherein each feedback signal is indicative of voltage drop of each LED string.

17. The LED driver of claim 11, wherein the reference voltage is the voltage across a setting resistor.

18. The LED driver of claim 11 further comprises a protection circuit for protecting the current balancing circuit from over voltage coupled between the LED string and the current source.

19. A method of driving a plurality of LED strings, the method comprising:
receiving an input signal;
deriving feedback signals indicative of voltage drops of each LED string;
generating a minimum feedback signal by selecting a feedback signal with minimum magnitude from the feedback signals;
providing a regulated current signal to each LED string, wherein the current of each LED string is substantially similar; and
generating a driving voltage in response to the input signal and the minimum feedback signal, the driving voltage being used to drive the plurality of LED strings.
